(19) United States
(12) Patent Application Publication
(10) Pub. No.: US 2003/0040310 A1
(43) Pub. Date: Feb. 27, 2003

(54) Extended mobile telephone network and payphone therefor

(76) Inventors: Simon Barakat, Oslo (NO); Jean-Paul Mengus, Montmagny (FR); Kambiz Safinya, Garches (FR)

Correspondence Address: ROSENTHAL & OSHA L.L.P., 1221 MCKINNEY AVENUE, SUITE 2800, HOUSTON, TX, 77010, US

(21) Appl. No.: 10/240,060

(22) PCT Filed: Mar. 19, 2001
(86) PCT No.: PCT/FR01/00811

(30) Foreign Application Priority Data
Mar. 28, 2000 (FR) 00/03923

(51) Int. Cl. H04Q 7/20

(52) U.S. Cl. 455/426; 455/422

(57) ABSTRACT

The invention concerns a mobile telephone network (XPLMN) characterised in that it comprises: (a) a radio subsystem (XBBS) and management and routing subsystem (ENSS); (b) said radio subsystem (XBBS) comprising at least a first base station (BTS) link and a second base station (XBTS) link and a link of the base station controllers (BSC, XBSC); (c) the base stations (XBTS) of the first link, communicating directly with their associated base station controllers (BSC) with specific means; (d) the base stations (XBTS) of said second link, communicating with the associated base station controller (XBSC) via the public switched telephone network (PSTN).

This invention concerns the mobile radiotelephony networks. It also concerns the telephone equipment at the public's disposal, also called public telephones or pay phones, classically connected to the public switching telephone network.

The current radiotelephony networks, whatever their type (GSM, CDMA, TDMA, AMPS, D-AMPS or PCS) have been originally designed to ensure telecommunications between users and have therefore been more particularly developed to transmit the voice.

Today, these networks are subject to the double constraint of having to satisfy an ever growing number of users and also of having to transfer an ever growing quantity of high rate information, in particular to access the global network of Internet. Thus, the GSM mobile radiotelephones don't exceed the rate of 9.6 kbits/second, whereas a connection via the public network of telephone switching through a computer and modem may reach 56.6 kbits/ second.

To comply with these requirements, the solution currently studied by mobile radio telephony operators is to increase both the network density, and in particular that of its radio sub-system ensuring, via relays consisting in the base stations and the controllers, the geographical coverage of a given area, and also to modify the technology used to increase the performance, especially regarding the information rate.

This increase in the density and performances of mobile radiotelephony networks requires however heavy financial investments, technologically as well as in infrastructure.

Installing, for instance, a new base station means buying or renting an appropriate site, actually installing the base station and connecting it to the network and in particular to its associated controller.

Regarding the new technologies now studied to increase the performances of mobile radiotelephony networks, there should be mentioned the GPRS (an English short for General Packet for Radio Services), which allows reaching theoretical rate of 144 kbits/ second by grouping the data in packets instead of cutting them up and sending them in slices of a few bits, the EGPRS (Enhanced General Packet for Radio Services) that can reach 384 kbits/ second if the radio waves modulation is changed, and especially UMTS (Universal Mobile Telecommunication System)that allows up to 2 Mbps. These new technologies, in particular the last one, UMTS, require a frequency evolution (2 GHz instead of today's 900 or 1800) but also coding algorithms, telephone terminals, aerials and various relays. Implementing these new technologies thus compels the operators to change altogether the current networks.

This invention therefore aims at increasing the performances of a mobile telephony network regarding the availability and the rate of information transmitted, without causing a large extra cost, using the public switching telephone network, in particular the pay phones connected to it. This invention thus concerns a mobile radiotelephony network. According to the invention, this network is characterised in that it includes:

a radio sub-system and a management and routing sub-system;

the radio sub-system with at least a first meshing and a second meshing of base stations as well as their associated base station controllers;

the first meshing base stations, directly communicating with their associated base station controllers via specific means; the second meshing base stations communicating with the associated base station controllers through the public switching telephone network.

According to another feature of the mobile radiotelephony network, the subject of this invention, the base stations in the second meshing are situated close or very close to a network of sets connected to the public switching telephone network, to take advantage of an existing infrastructure and limit the installation cost.

According to another feature of the mobile radiotelephony network subject of this invention, these sets are pay phones the number and geographical distribution of which are particularly well suited for developing a mobile radiotelephony network.

According to another feature of the mobile radiotelephony network subject of this invention, the controllers associated with the base stations in the second meshing communicate with the management and routing system via the public switching telephone network.

According to another feature of the mobile radiotelephony network subject of this invention, the controllers associated with the base stations in the second meshing are connected with the public switching telephone network via high rate modems.

According to another feature of the mobile radiotelephony network subject of this invention, the base stations in the second meshing cooperate with many communication interfaces, which allows different mobile stations to access the public switching telephone network. This allows new services to be offered to the mobile radiotelephony network users without using necessarily new communication technologies.

This invention also concerns a pay phone of the type with a terminal connected with the public switching telephone network.

The pay phone, according to this invention is characterised in that it also includes a base station of a mobile radiotelephony network, such base station being connected to the rest of the mobile radiotelephony network via the public switching telephone network.

According to another feature of the pay phone subject of this invention, the base station is connected with the public switching telephone network via a high rate modem.

According to another feature of the pay phone subject of this invention, the base station cooperates with a number of communication interfaces allowing different mobile stations to access the public switching telephone network.

The aims, aspects and advantages of this invention will be better understood with the description given hereafter of different modes of embodiment of the invention, shown as non-limiting examples, by referring to the attached drawings, where:

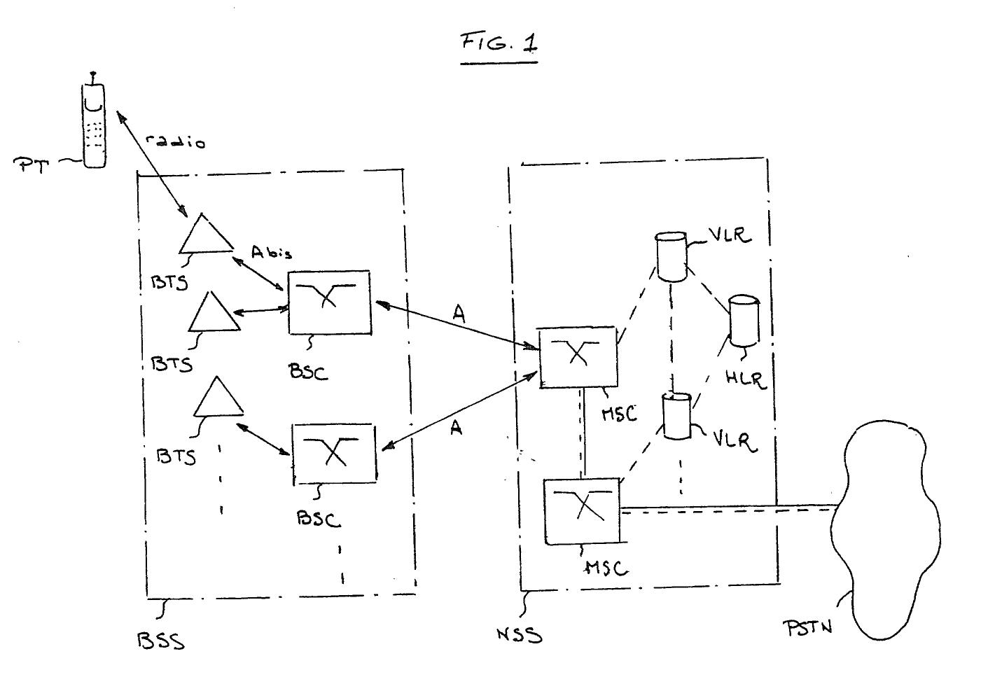

FIG. 1 is a principle view of a mobile telephone system architecture as known today;

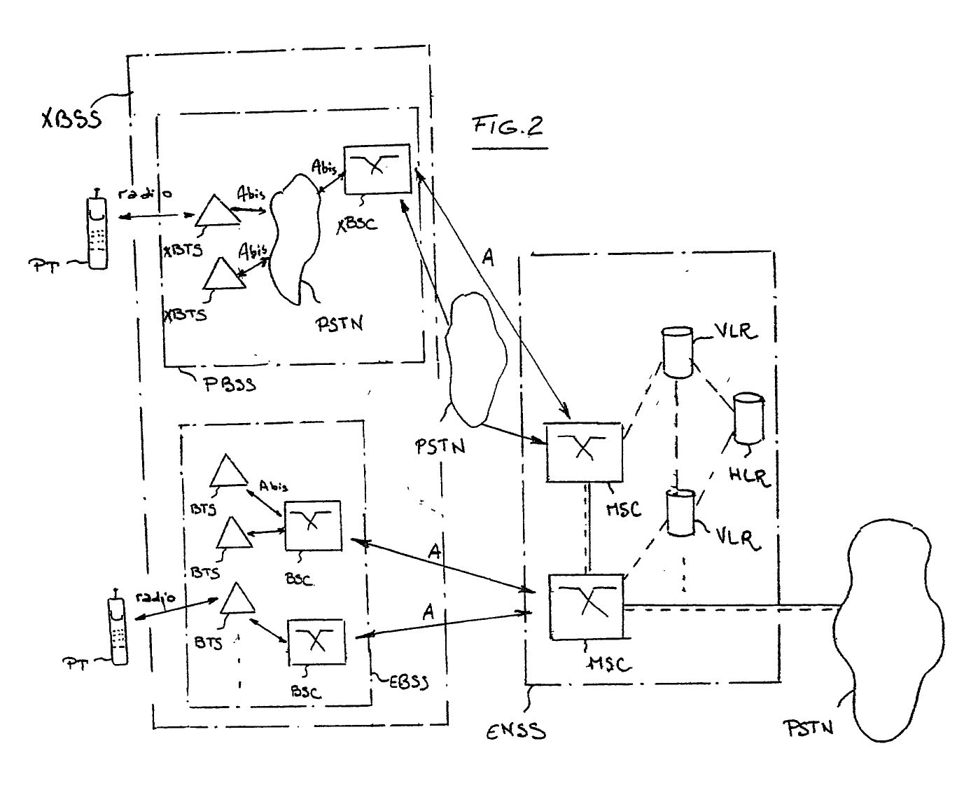

FIG. 2 is a view similar to FIG. 1, showing an example of the extended mobile telephony network subject of this invention;

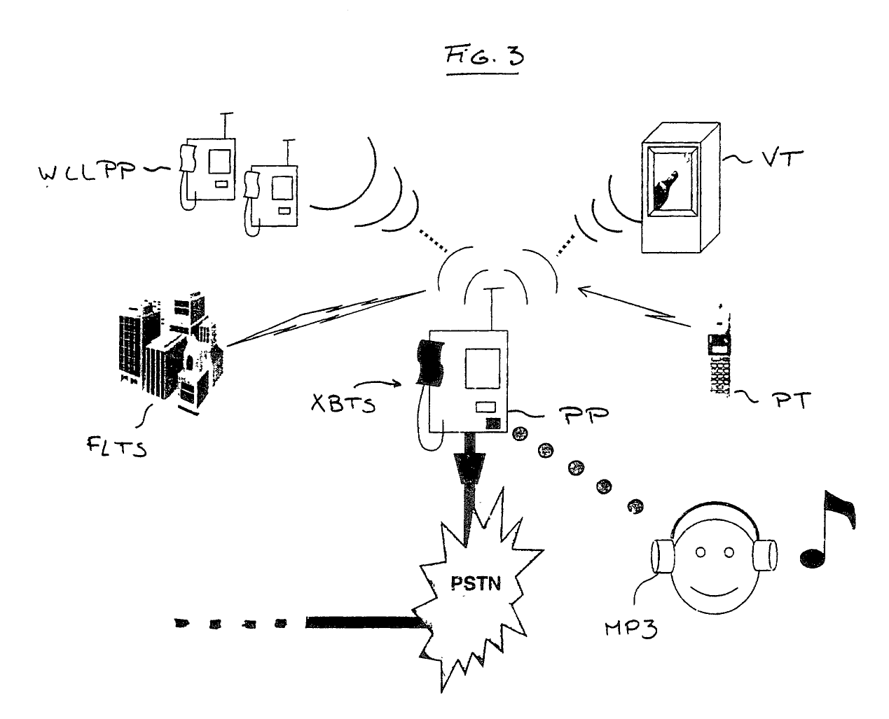

FIG. 3 is a schematic diagram of the functions of a base station integrated with the extended mobile telephony network according to a particular mode of embodiment of this invention.

The basic architecture of a mobile telephony network PLMN (English short for Public Land Mobile Network) known today and shown on the synoptic diagram of FIG. 1.

Such architecture, that is for instance that of a GSM network but also that of the CDMA, TDMA, AMPS, D-AMPS or PCS networks, enables the making of digital communications between mobile telephones and between mobile telephones and fixed stations of the public switching telephone network PSTN.

This standard architecture of mobile telephony PLMN includes PT mobile radiotelephones (mobile station), BSS radio sub-systems (Base Station System), and management and routing sub-systems NSS (Network and Switching Sub-system).

A BSSZ radio sub-system is an equipment ensuring the cover of a given geographical area. This BSS radio sub-system ensures a control function using base station controllers (Base station Controller) and a radio transmission function assisted by BTS base stations (Base Transceiver Station). Each BTS base station covers a territory called cell. This cell manages the links with the PT mobile telephones using an interface named radio interface. The BTS base stations are directly connected to BSC base station controllers, via cables in a clean site or by radio. Communications between a BTS base station and its BSC base station controller are defined by an interface called Abis interface. Communications between the BSC base station controllers and the management and routing NSS sub-system are also made by cable in a clean site or by radio, using an interface named interface A.

The NSS management and routing sub-system comprises mainly a set of elements hereafter named MSC, HLR and VLR. The MSC elements (Mobile Service Switching Centre) are switching centres for the mobile radio service responsible for routing communications from and to PT mobile telephones as well as to the PSTN public switching telephone network. Each MSC element is connected via the interfaces A to a set of BSC base station controllers as well as to the other MSC elements in the network. Each MSC element is also linked to HLR and VLR elements. The HLR elements are data bases where the subscribers parameters are recorded; they also include for each PT telephone some information enabling it to be located, updated permanently. Finally, the VLR elements are data bases in which are recorded the fine locations of the mobile PT telephones in the call zone.

The PLMN mobile telephone network structure is therefore cellular, its capacity is obtained by meshing the territory with cells, each served by a base station.

If one refers to FIG. 2, there is shown an extended mobile telephony network XPLMN (Extended Public Land Network) according to this invention. This network comprises Mobile Stations MS, extended radio subsystems XBSS and management and routing sub-systems ENSS.

MS mobile station means a physical equipment used by a user moving through the geographical zone covered by the XPLMN network. Such mobile station may be a mobile radiotelephone terminal or o laptop computer or a personal communicator communicating via an infrared link, a VT dispensing machine (Vending Terminal) accepting payments by telephone calls using the Blue Tooth technology, an audiophonic reader in the MP3 format able to download musical programmes via an infrared link, etc.

The extended radio sub-system XBSS comprises two sets or meshing of base stations.

The first meshing EBSS shown comprises a base station network BTS completely similar to those used in the BSS radio sub-systems shown in FIG. 1. These base stations BTS are distributed so as to ensure coverage of the whole geographical territory matching the network. For this first meshing, the BTS base stations are normally connected with their associated base station controllers BSC via Abis interfaces, which BSC base station controllers are in turn connected to the management and routing ENSS subsystem via interface A.

This first meshing may therefore well comprise the radio sub-system of an existing mobile radiotelephony network.

The second meshing PBSS comprises XBTS base stations. The base stations XBTS are designed according to a technology completely similar to that of the EBSS base stations in the first meshing. According to a mode of embodiment particularly interesting of the invention, these XBTS base stations are located with PP publiphones (Pay Phones) also called telephone boxes.

Publiphones are classical terminals in the PSTN public switching telephone network that may be temporarily used by a user to communicate with a called subscriber, being understood that the said user must fulfil a number of obligations regarding the communication payment.

The physical installation of XBTS base stations may be made in several ways. Either they are directly integrated with payphone terminals which are then specially designed to allow such integration, or they are placed outside these boxes. The main thing, according to one of the points in the invention, is that each XBTS base station be connected to a corresponding XBTS base station controller via the PSTN public switching telephone network.

The interface between the XBTS base stations and the XBSC base station controllers is of the Abis type, and the link is ensured through the PSTN network via high-rate modems (not shown) of the HDSL, DSL type, with the frequency band 0-4 kHz being kept for pay phone utilisation.

The XBSC base station controllers are connected with MSC switching centres for the mobile radio service of the ENSS management and routing sub-system, either directly via classical interfaces A, or via the PSTN public switching telephone network through high-rate modems that are not shown, of the type HDSL, DSL, . . .

With this double base station meshing, BTS and XBTS, the mobile station user can take advantage of a high capacity network and can access a large choice of services. This is because he can take advantage, in particular, when it is a question of telephoning highly dense mobile telephone network performances, but he can also, getting closer to an XBTS base station, benefit by additional services, as detailed hereafter facing FIG. 3.

The use of payphones to accept XBTS stations shows many advantages, in particular the easier location of XBTS stations by users, especially concerning the use of additional services. It also enables an easier installation and connection with the PSTN network. As the density of payphones is particularly well matching the population density and its moves or centres of interest, this results in a particularly suited sizing for the users needs, therefore a low risk of seeing the network being saturated. Also, by integrating the XBTS sub-stations with pay phones, it is possible to ensure a move of the XBSS sub-system for a relatively low cost, since the infrastructures concerning the pay phones already exist. Finally, the use of the PSTN network offering low cost services, it is possible to reduce the cost of the XPLMN extended mobile radiotelephony network.

Of course, these XBTS base stations may be located in other places than pay phones, with as the only constraint, the need to connect the XBTS stations with the PSTN network. It could be for instance arranged to install together XBTS stations with banknote automatic dispensers, that are also connected with the PSTN network and are also easily found by the user.

Looking at FIG. 3, there are shown in a schematic way the new functions offered to the user by using the XBTS base station connected to the PSTN network.

In the example shown in FIG. 3, the XBTS base station is integrated with a PP pay phone. The base station is connected with the PSTN network via a high-speed modem, for example using the ADSL technology (Asymmetrical Digital Subscriber Line), that distributes frequencies between Internet and the telephone. Of course, other high-speed modem technologies may be used, such as ISDN, DSL, etc., in order to increase the pass-band and the rate.

According to this example of embodiment, the XBTS base station is adapted, in particular using a set of interfaces, in order to operate with a large range of radiotelephone communication protocols such as GSM, CDMA, TDMA, AMPS . . . , so as to be used by various mobile radiotelephony networks. Of course, the XBTS base station could be configured to operate only according to a communication protocol, the one used by the network, for example GSM.

Again according to the mode of embodiment shown, the XBTS base station is configured to accept communications of smaller amplitude than those using the DECT, Blue Tooth or infrared protocols. Of course, this arrangement is again not limiting this invention.

So fitted, the PP pay phone can offer a whole range of services.

Of course, the first service covered is the classical pay phone service, which remains unchanged. Then, there is the base station service for the mobile phones of the XPLMN network, this service improving the network cell meshing and thus offering a better capacity to deal with the dial-ins and the dial-outs, even if the number of users is large, as the network cell size is very much reduced.

Another possible service is, using an )audiophonic reader MP3, to download via an infrared link, a recording in the MP3 format from Internet via the pay phone.

Also, it is possible to easily install a VT automatic dispenser (Vending Machine) allowing owners of mobile phones to buy products contained in the machine via a simple call. The VT machine then communicates the sum to be debited to its server via the pay phone, using a Blue Tooth link. As this VT machine does not require a fixed link with the PSTN network, it can be easily installed and moved around the PP pay phone.

WLLPP public radiotelephones (Wireless Local Loop Public Phone) can also be used in the neighbourhood of pay phones if they are connected with the PSTN network, not by costly cables to be installed but by a CDMA or other link transiting via the PP pay phone.

It is also possible to use this PP pay phone to ensure communication between a FLTS building (Fixed Line Telephone Service) fitted with a local radiotelephony installation, and the PSTN public switching network. The connection between this radiotelephony installation and the PSTN network is then ensured by the PP pay phone, through a WAN (Wide Area Network) using a PCS link.

It can thus be seen that, by associating base stations of the mobile radiotelephony network with the pay phones of the PSTN network, the density is highly increased, and so is the quality of this mobile radiotelephony network, with a extra cost rather low relating to infrastructures, since existing sites are used and the links between these base stations and the rest of the network elements is made via the PSTN network. Also, and in a particularly remarkable way, the network density is increased where the XPLMN network is very much in demand, i.e. in the areas highly built or very much visited such as railway stations, since these areas are fitted with a high number of pay phones. Further, the use of the PSTN network to connect XBTS base stations with XBSC controllers enables a better management of these controllers and a easier installation.

Finally, the possibility that is offered to communicate according to many communication protocols and to directly access the PSTN network allows many possibilities, as has already been shown in FIG. 3.

Of course, the functions illustrated are only described as examples and do not limit the possibilities that can be implemented through this invention.

1. Mobile radiotelephony network (XPLMN) characterised by its comprising:
a radio subsystem (XBSS) and a management and routing sub-system (ENSS);
the said radio sub-system (XBSS) comprising at least a first meshing (EBSS) of the base station (BTS) and a second meshing (PBSS) of base stations (XBTS) as well as the associated base station controllers (BSC, XBSC);
the base stations (BTS) of the said first meshing (EBSS) communicating directly with their associated base station controllers (BSC) via specific means;
the base stations (XBTS) of the said second meshing (PBSS), communicating with the associated base station controllers (XBSC) via the public switching telephone network (PSTN).

2. Mobile radiotelephony network according to claim 1, characterised in that the said base stations (XBTS) of the said second meshing (PBSS) are located in or in the immediate neighbourhood of a network of instruments connected to the public switching telephone network (PSTN).

3. Mobile telephony network according to claim 2, characterised in that the said instruments are pay phones.

4. Mobile telephony network according to any of the claims 1 to 3, characterised in that the said base stations (XBTS) of the said second meshing (PBSS) are connected to the public switching telephone network (PSTN) via high-rate modems.

5. Mobile telephony network according to any of the claims 1 to 3, characterised in that the said controllers (XBSC) associated with the said base stations (XBTS) of the said second meshing (PBSS) communicate with the said management and routing sub system (ENSS) via the public switching telephone network (PSTN).

6. Mobile telephony network according to claim 5, characterised in that the said controllers (XBSC) associated with the said base stations (XBTS) of the said second meshing (PBSS) are connected with the public switching telephone network (PSTN) via high-rate modems.

7. Mobile telephony network according to claim 1, characterised in that the said base stations (XBTS) of the said second meshing (PBSS) cooperate with many communication interfaces allowing various mobile stations (MS) to access the public switching telephone network (PSTN).

8. Pay phone comprising a terminal connected to the public switching telephone network (PSTN), characterised in that it comprises also a base station (XBTS) of a mobile radiotelephony network (XPLMN), the said base station (XBTS) being connected to the rest of the mobile radiotelephony network (XPLMN) via the said public switching telephone network (PSTN).

9. Pay phone according to claim 8, characterised in that the said base station (XBTS) is connected to the public switching telephone network (PSTN) via a high-rate modem.

10. Pay phone according to any of claims 8 to 9, characterised in that the said base station (XBTS) cooperates with a number of communication interfaces enabling different mobile stations (MS) to access the public switching telephone network (PSTN).
